(19) United States
(12) Patent Application Publication
(10) Pub. No.: US 2010/0138376 A1
(43) Pub. Date: Jun. 3, 2010

(54) METHOD AND SYSTEM FOR SEARCHING FOR PATTERNS IN DATA

(76) Inventors: Nicholas John Avis, Altrincham (GB); Frederic Kleinermann, Overrijse (BE)

Correspondence Address: DEFILLO & ASSOCIATES, INC., P.O. Box 14104, Clearwater, FL, 33766, US

(21) Appl. No.: 12/524,273

(22) PCT Filed: Jan. 23, 2008
(86) PCT No.: PCT/GB08/00226

§ 371 Date: Jan. 26, 2010

(30) Foreign Application Priority Data
Jan. 24, 2007 (GB) 0701344.4
Feb. 2, 2007 (GB) 0702035.7
May 1, 2007 (GB) 0708395.9

(51) Int. Cl. G06N 5/02; G06K 9/46; G09G 5/36; G06K 9/00; G06F 15/16; G09G 5/02; G06F 12/00

(52) U.S. Cl. 706/50; 382/190; 345/545; 382/165; 345/502; 345/589; 711/154; 706/54; 711/E12.001

(57) ABSTRACT

Methods and systems for searching by computer for patterns in data are disclosed. These have particular, but not exclusive application to searching for target nucleotide sequences within a gene database. In the method can be performed by a computer that computer includes a central processing unit (CPU) that has one or more processing core, main memory accessible for read and write operations by the CPU, one or more graphics processing unit (GPU), and graphics memory accessible for read and write operations by the GPU. The method includes a step in which data to be processed as part of the pattern matching algorithm are transferred to the graphics memory, the GPU is operated to perform one or more processing step on the data. Following completion of the processing step, processed data are transferred from the graphics memory to the main memory. Algorithms that can be implemented using the invention include deterministic algorithms (e.g., Smith-Waterman) and non-deterministic algorithms (e.g., BLAST).

### CROSS REFERENCE TO RELATED APPLICATION

This application is a national stage entry of PCT/GB2008/000226 filed Jan. 23, 2008, under the International Convention claiming priority over Great Britain applications No. 0701344.4 filed Jan. 24, 2007; Application No. 0702035.7 filed Feb. 2, 2007; and Application No. 0708395.9 filed May 1, 2007.

This invention relates to a method and system for searching for patterns in data. It has particular, but not exclusive, application to searching for patterns in very large sets of data. More specifically, embodiments of the invention may be applied to searching sets of data that describe gene sequences. Alternative embodiments of the invention may find application in searching data representative of other things, such as music, images, video, datasets representing biometric information, computer virus signatures, to name but a few.

Data associated with biological science is expanding at a substantial rate. To illustrate this, more than 300 complete genome sequences have already been completed and several more are on their way resulting in the expansion of various gene databases. For instance, the GenBank database has, as of August 2006, more than 17×10⁶ sequence entries with more than 80×10⁹ base pairs. The size of available sequence data is doubling on average every 15 months, exceeding even the famous “Moore's law” associated with computational component capacity.

Databases such as GenBank contain nucleotide sequences and protein sequences. The first step commonly performed by a biologist when investigating a new sequence is to compare it against GenBank to find similar sequences using a computer executing a gene sequence comparison algorithm. Since the databases are still growing faster than computer hardware is increasing in power, search speed is a very important consideration when implementing systems for scanning sequence databases. This explains the previous and continued effort to find efficient algorithms and systems to perform these tasks.

Gene sequence comparison algorithms operate by computing alignment scores between a query sequence and target sequences. A score represents the degree of similarity between the query and a target sequence of the database. This score is computed by aligning both sequences, and using a substitution score matrix and a gap penalty function.

Modern personal computers most typically include one or more central processing units that have a streaming single instruction, multiple data (SIMD) instruction set and associated registers. These include the SSE set on Intel processors, the AltiVec instruction set on the PowerPC processor, and the 3D-Now instruction set on AMD processors. These instruction sets include single instructions that can perform integer or floating-point arithmetic on multiple operands so avoiding the need to perform looping or other iteration over the data. The principle intention behind providing such instructions is to facilitate and accelerate graphical, image and video processing applications. However, their use is not limited to such applications. Since these SIMD instructions are performed in hardware, they can perform arithmetic on sets of data considerably more rapidly than would be possible using conventional instructions, each operating on a single item of data, in a loop.

These SIMD instruction sets can be used in stream processing. Stream processing is an efficient, high-performance technique for performing operations that require vector processing of a large set of data. Given a set of input and output data (these are the streams), stream processing applies a series of computer-intensive operations (called “kernel functions”) to each element in the stream. The programming language “Brook” was developed to simplify implementation of stream processing systems. Brook is an extension of standard ANSI C and is designed to incorporate the ideas of data parallel computing and arithmetic. The streaming computational mode provides two main benefits over traditional conventional approaches to computation applied to large sets of data: it provides data parallelism, which allows a programmer to specify how to perform the same operations in parallel on different data; and arithmetic intensity, which allows a programmer to specify operations on data which minimise global communication and maximise localised computation.

Graphics processing units (GPUs) are used in computer video hardware to perform the calculations necessary to render 2-dimensional and 3-dimensional video content. In order to achieve this, a GPU is capable of performing floating-point computations with very high throughput. Moreover, GPUs are typically able to access graphics memory at very high speed. In a modern graphics card, this memory may amount to several hundred megabytes or even several gigabytes. Some aspects of the performance of graphics processing units have increased at a rate that is considerably greater than the increase of the performance of CPUs over the same period, as illustrated in FIG. 14. In particular, the programmable floating-point performance of GPUs (measured on the multiply-add instruction) has increased dramatically in recent years when compared with CPUs. Therefore, modern graphics hardware includes considerable arithmetical processing power. Although graphics processing units are provided to process data that represents a graphical image, there is, in principle, no reason why they should not be used to process arbitrary data. Researchers have realised that this processing power can be used to advantage when performing some calculations, and stream processing has been found to be a particularly appropriate application.

### Introduction to Bioinformatics Searching Algorithms

The algorithms that are used in searching biological sequences fall into three broad classes: Monte-Carlo, non-heuristic and heuristic. This invention is particularly concerned with implementation of algorithms in the latter two of these classes, including the non-heuristic Smith-Waterman algorithm and the heuristic BLAST algorithm. Although these are well-known to those in the technical field, they will be described here briefly in order that the nature of the invention will be better understood.

Known algorithms are typically based on a string edit distance optimisation as first presented by Needleman and Wunsch (“A general method applicable to the search for similarities in the amino acid sequence of two proteins.” J. Molecular Biology vol. 48, pp 443-453, 1970), and later expanded and extended by Smith and Waterman (“Comparison of Biosequences”. Adv. Appl. Math. 2, pp 482-489, 1981). Following its design by Smith and Waterman in 1981, the Smith-Waterman algorithm was improved by Gotoh in 1982 and then optimised by Green in 1993. This algorithm gives the optimal score for linear gap penalty function. This algorithm has been proven to be the most accurate. However, it is also the most computational demanding not only in terms of memory, but also in terms of processing speed. This algorithm utilises dynamic programming techniques and is therefore slow on ordinary general-purpose computers.

Heuristic algorithms have been developed to address these performance limitations. Examples include FASTA (Person and Lipman, 1988) and BLAST (Altschul et al., 1990; Altschul et al., 1997). These algorithms typically reduce the run time by a factor of up to 40 compared to the best-known Smith-Waterman implementation on non-parallel, general-purpose computers. A disadvantage is that this performance increase is often achieved at the expense of accuracy. For instance, some distantly related sequences might not be detected in a search using these heuristic algorithms.

Accuracy and speed are both very important, so a number of techniques have been developed to produce fast implementations of the Smith-Waterman algorithm and its variants. From the description of Smith-Waterman algorithms presented below, it is clear that the algorithm is both memory-hungry and requires frequent memory fetches and writes to adjacent Smith-Waterman score matrix cells. Since the full score matrix is unlikely to be small enough to fit into processor memory caches, these memory fetches and updates result in inefficiencies due to the mismatch between the processor and memory speeds on typical general-purpose computers.

Traditional parallel processing methods based on multiple-instruction-multiple-data (MIMD) techniques suffer from the same bottlenecks identified above with the added complication of partitioning the dataset across the processors and handling the resultant inter-processor communications. Vector computers typically have much closer matched memory bandwidths to processor speeds and these would appear good candidate architectures for the efficient implementation of the Smith-Waterman algorithm. However, the algorithm requires that some score cell updates are computed in strict order whilst others are independent of each other and can updated in parallel, this leads to inefficiencies associated with typical vector processing approaches.

Taylor (1998 and 1999) applied the MMX technology to the Smith-Waterman algorithm and achieved a speed of 6.6 million cell updates per second on an Intel Pentium III 500 MHz microprocessor.

Whilst improvements in execution speed can be achieved by using embedded and co-processor SIMD capabilities of modern general-purpose computer platforms, these are not keeping pace with computational requirements associated with increases in the genome database sizes.

The second approach resulted in the development of a number of special-purpose hardware solutions with parallel processing capabilities, such as Paracel's GeneMatcher, Compugen's bioaccelerator and TimeLogic's DeCypher. These special-purpose machines use a systolic array configuration consisting of hundreds or sometimes thousands of small processing elements interconnected as a two-dimensional array, to produce a direct hardware implementation of the dynamic programming algorithms used in biosequence analysis. These machines are able to process more than 2000 millions matrix cells per second, and can be expanded to reach much higher speeds. However, such machines are expensive and cannot readily be exploited by ordinary users. Some hardware implementations of the Smith-Waterman algorithm are described in U.S. Pat. No. 5,553,272, U.S. Pat. No. 5,632,041, U.S. Pat. No. 5,706,498, U.S. Pat. No. 5,964,860 and U.S. Pat. No. 6,112,288.

It is clear that there has been continued and increasing interest in the use of hardware acceleration techniques and special-purpose hardware aimed specifically at accelerating genetic sequence analysis (comparisons) since the late 1980s. Special-purpose systems have ranged from several chips on a PCI board to server-sized machines, but all present solutions suffer from a number of disadvantages, including cost, ease of use and performance. Therefore, there appears to be a demand for a system that scales and allows hardware acceleration of searching algorithms, which is cheap, provides good performance in a flexible and easy-to-use manner, and which avoids the need to procure and operate special-purpose hardware solutions. Central to achieving this is the realisation that the operations required to perform sequence comparisons and scoring of two or more strings can be recast as a multi-pass rendering problem involving texture mapping and image filtering operations that can be efficiently executed on modern GPUs.

### Dynamic Programming

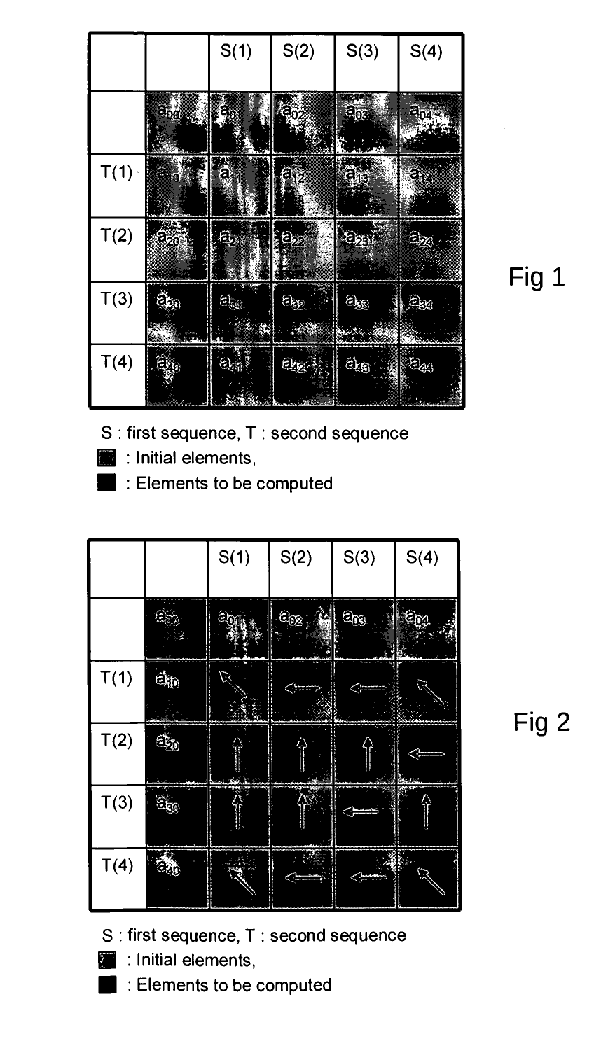

Dynamic programming techniques for pairwise alignment include two main steps. In the first step, a score is computed between individual letters of the first sequence (S) and the individual letters of the second sequence (T) according to an alignment scoring function. This step populates a matrix where the rows correspond to the letters of the first sequence S and the columns correspond to the letters of the second sequence T. This is illustrated in FIG. 1.

Once the score has been computed, the method establishes and records for each of the cells, which of the other cells in the matrix contributed the most to its score. This information is called “backtracking information” and can be computed at the same time as the computation of the score. This information is used in the second stage of the dynamic programming algorithm associated with retrieving optimal alignments. Backtracking information is often represented by a pointer pointing “up”, “left” or “diagonally” to indicate which previous elements of the matrix has contributed the most to the score of an element, as shown in FIG. 2.

Based on the backtracking information, the backtracking will be different according to the type of alignment scoring function used.

Backtracking for local alignment. In local alignment, the backtracking algorithm starts by retrieving the element having the maximum score. Then from that element, it uses the stored backtracking information to back track until it reaches a score of zero. However, there can be several possible alignments if there are many elements having the same maximum score.

Backtracking for global alignment. In global alignment, only one alignment is retrieved. The backtracking algorithm starts from the last element (m, m) of the matrix alignment and stops when it reaches the first element (0, 0). To reach that element, it follows the path defined by the stored backtracking information.

### Non-Heuristic and Heuristic Algorithms Compared

Non-heuristic algorithms are guaranteed to find optimal score according to the specific scoring scheme. In particular, affine gap versions are regarded as providing the most sensitive sequence matching methods available. However, they are not the fastest available sequence alignment methods, and in many cases speed is an issue. For this reasons, there have been many attempts to produce faster algorithms than straight dynamic programming. This will be introduced later in this section with BLAST.

The alignment scoring function for local alignment (Waterman et al. 1976, Smith and Waterman, 1981a,b) and involving simple gaps is given by:

$$Score ( {element}_{ij} ) = max \{ \begin{matrix}0 \\ Score ( {element}_{i - 1 , j} ) + δ ( {S}_{i} , - ) \\ Score ( {element}_{i , j - 1} ) + δ ( {-}_{i} , {T}_{i} ) \\ Score ( {element}_{i - 1 , j - 1} ) + δ ( {S}_{i} , {T}_{i} ) ,\end{matrix}$$

where δ(Si,Tj) is the score of aligning Si against Tj, δ(Si,-) is the cost of opening a gap along string S, δ(-, Tj) is the cost of opening a gap along string T.

The alignment scoring function for global alignment (Needleman-Wunsch, 1970) is given by:

$$Score ( {element}_{ij} ) = max \{ \begin{matrix}Score ( {element}_{i - 1 , j} ) + δ ( {v}_{i} , - ) \\ Score ( {element}_{i , j - 1} ) + δ ( {-}_{i} , {w}_{i} ) \\ Score ( {element}_{i - 1 , j - 1} ) + δ ( {v}_{i} , {w}_{i} )\end{matrix}$$

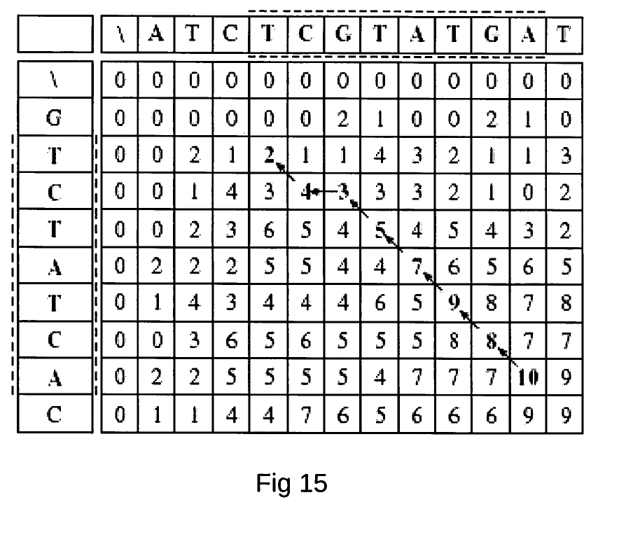

FIG. 15 shows an example of an alignment score matrix associated with the Smith-Waterman algorithm. The query is the sequence GTCTATCAC and the target is ATCTCGTATGAT. The alignment score matrix in FIG. 15 is shown with a linear gap cost alpha=1, and a substitution cost of +2. If the characters match a score of +2 is awarded, or −1 otherwise. From the highest score (+10 in the above example), a backtracking procedure delivers the corresponding local alignment.

Non-heuristic algorithms use dynamic programming to obtain the optimal alignment under a given scoring system in a time that is proportional to the product of the lengths of the two sequences being compared. Therefore, when they are applied to an entire database, the computational time grows significantly with the size of the database. With current sequence databases, calculating a full alignment for each sequence of the database using these dynamic programming techniques is often a slow process even given access to large computational resources. Nevertheless, these non-heuristic algorithms are considered to be the best algorithms for producing an accurate alignment. This is why effort has been made to implement these algorithms have been implemented on specialized parallel hardware.

Complementary to non-heuristic algorithms are heuristic algorithms. These alternative algorithms are based on heuristic programming approaches which trade-off accuracy for speed. As mentioned above, FASTA and BLAST typify the algorithms associated with this heuristic approach. Both of them use the principle of first identifying short, highly-similar segments which can then be expanded. One of the main assumptions associated with both of these algorithms is that one or more of these similar segments must be part of any significant alignment. The heuristic approaches are faster than dynamic programming when scanning large databases as they avoid the need to fully construct an alignment matrix. Instead, they start by filling a subset of entries of the alignment matrix forming common sub-sequences of high similarity. Next, the neighbouring entries are filled (or calculated) until the score of an extended aligned segment is maximized. The complexity of the heuristic algorithms remains of the order of (N×M). But they win in comparison to dynamic programming in terms of speed because the number of computations based on residue-residue comparisons is significantly reduced. Although these algorithms are faster than dynamic programming algorithms, they are still computationally demanding. For this reason, they have also been implemented on high-end and parallel computers.

The BLAST algorithm can be summarized in the following three steps.

Initial word search: this step identifies which diagonal region of both the query and database sequence contain sufficient similarity for further consideration. To achieve this, BLAST divides the sequence into a list of overlapping words. BLAST extends this list to include all words that score above a specific matrix-defined threshold for the specified matrix. This value limits the number of matches that will survive this first step.

Initial alignment: this step creates an initial alignment in the identified regions and determines if this alignment is statistically significant. The original BLAST algorithm does this initial alignment by taking each identified matching word and then extending this match in both directions along the diagonal, without gaps, until the alignment score goes below a cut-off point. The BLAST algorithm reports the best alignment if there were at least two identified non-overlapping words on a diagonal alignment before extending the alignment. Note that the default word size is 3 for protein and 11 for nucleotic acids, but these values may be modified.

Final alignment: this step performs a restricted alignment in the regions identified by the previous two steps. Note that the BLAST algorithm has undergone several refinements and the maximal scoring segment is used to define a band that uses the Smith-Waterman algorithm to find gapped alignment within the band. The recent gapped BLAST circumvents the problem of being restrained within an alignment region bounded by the window size while avoiding the high computational cost of unrestricted Smith-Waterman alignment by extending the alignment out from a central high-scoring sequences in a way analogous to how BLAST extends the initial maximal pair alignment. The initial pair of aligned amino acids is chosen as the middle pair of the highest-scoring, 11-residue window in the high-scoring segment pair alignment. The Smith-Waterman algorithm is then used to extend the alignment in both directions until the score falls below a fixed percentage of the highest score computed in the Smith-Waterman phase. The highest scoring Smith-Waterman alignment is found if firstly, the calculation is extended until a score of zero is obtained and secondly, the initial pair of amino acids selected as the midpoint from which to extends the actual alignment are part of the one that would be reported as the best by a complete Smith-Waterman alignment of the pair of sequences.

### SUMMARY OF THE INVENTION

An aim of this invention is to provide methods and systems whereby searches for sequence matches within a database can be performed more efficiently than is possible with conventional systems.

From a first aspect, this invention provides a method of performing a pattern matching algorithm (for example, on strings of characters) on a computer, which computer includes a central processing unit (CPU), main memory accessible for read and write operations by the CPU, a graphics processing unit (GPU), and graphics memory accessible for read and write operations by the GPU, in which the method includes a step in which data to be processed as part of the pattern matching algorithm is transferred from the main memory to the graphics memory, the GPU is operated to perform one or more processing operations on the data, and following completion of the processing operations, processed data is transferred from the graphics memory to the main memory.

The method therefore assigns part of the task of performing the algorithm to the GPU, thereby reducing the amount of processing that must be performed by the CPU. Careful selection of the processing operations that are performed by the GPU can also lead to an increase in performance as compared with what would be possible if the entire algorithm were performed by the CPU.

Embodiments of the invention may implement non-heuristic pattern-matching algorithms. As an example, embodiments may implement the Smith-Waterman algorithm.

Further embodiments of the invention may implement heuristic pattern-matching algorithms. As an example, embodiments may implement the BLAST algorithm.

From a second aspect, the invention provides a system for performing a pattern matching (for example, on strings of characters) comprising computing apparatus including a central processing unit (CPU), main memory accessible for read and write operations by the CPU, a graphics processing unit (GPU), and graphics memory accessible for read and write operations by the GPU, and program code which, when executed by the CPU, causes the system to perform a method according to the first aspect of the invention.

The CPU of such a system may include one or more processors each of which may include one or more processing cores. The system may include more than one GPU.

Embodiments of the invention will now be described in detail, by way of example, and with reference to the accompanying drawings, in which:

FIG. 1 illustrates an alignment score matrix that is populated during a bioinformatics search algorithm that uses dynamic programming, and has already been discussed;

FIG. 2 illustrates the alignment score matrix of FIG. 1 showing the backtracking relation between cells during a dynamic programming process, and has already been discussed;

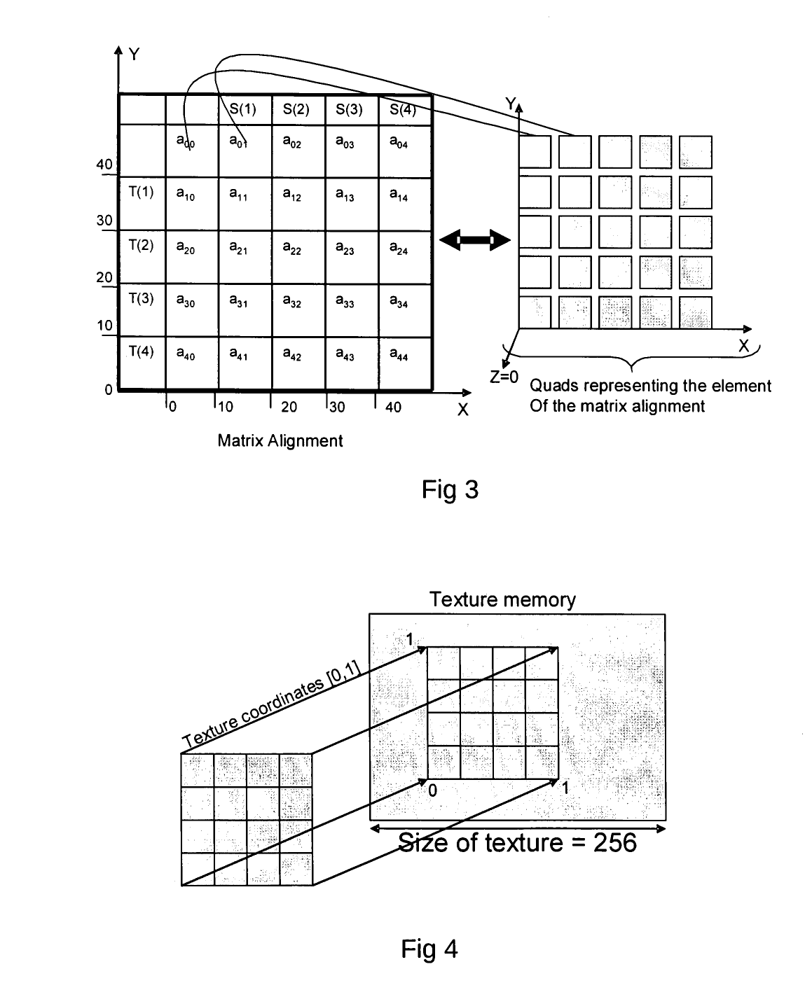

FIG. 3 illustrates the relationship between an alignment score matrix and graphic quads in a texture memory;

FIG. 4 illustrates an orthogonal relationship between graphic quads and elements to be computed in a dynamic processing operation;

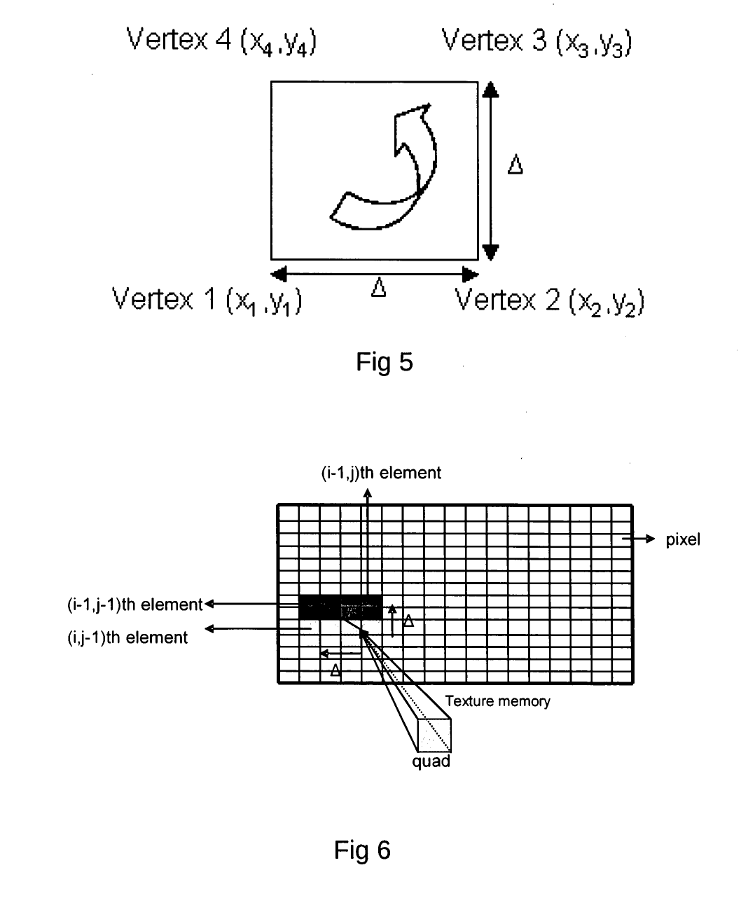

FIG. 5 shows the calculation of the address of data representing a quad in graphics memory;

FIG. 6 illustrates the location of data corresponding to an item of data in a dynamic programming matrix within a texture memory of a GPU;

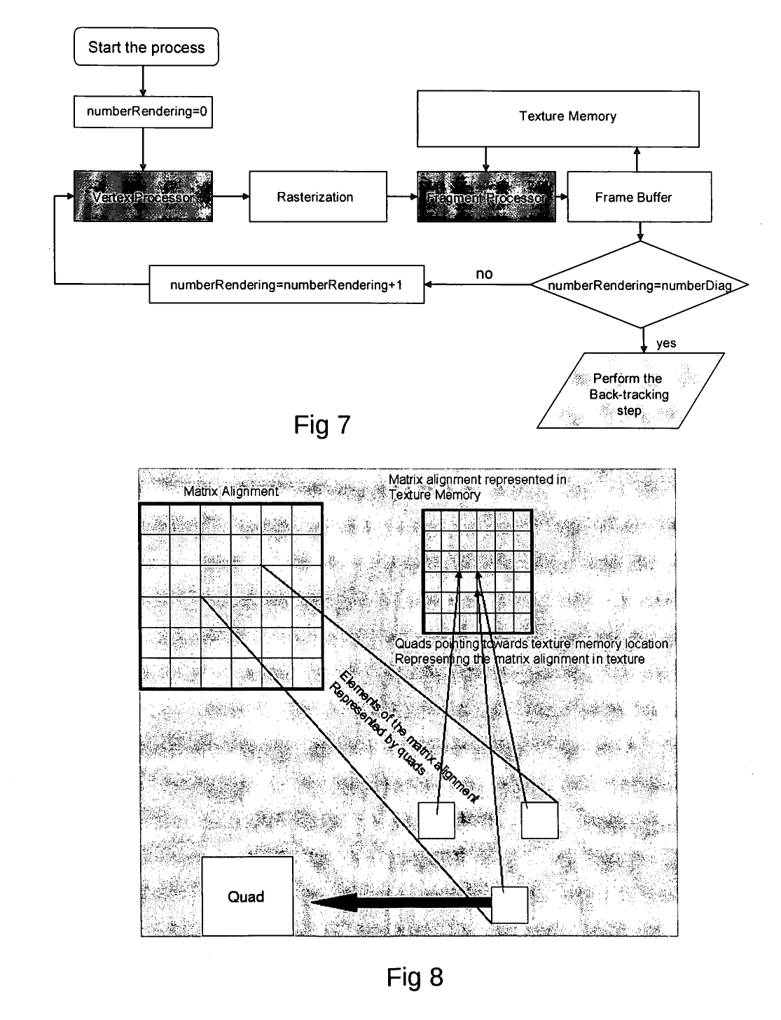

FIG. 7 is a flow chart that illustrates rendering of quads in performance of a method embodying the invention;

FIG. 8 is a diagram that illustrates that a cell can only access data from a previous rendering pass;

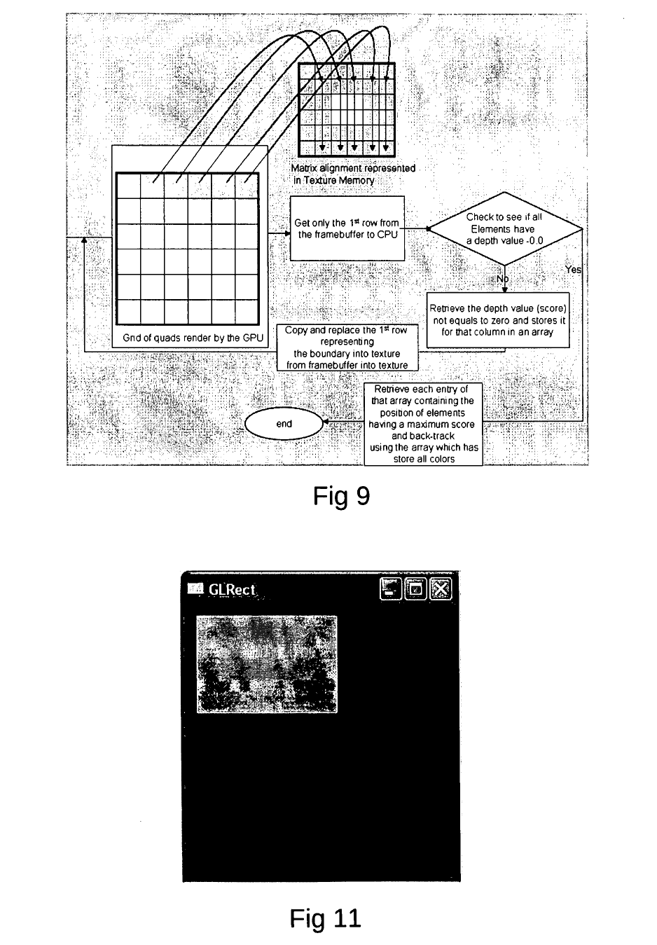

FIG. 9 is a flow chart that described backtracking performed as part of an algorithm embodying the invention;

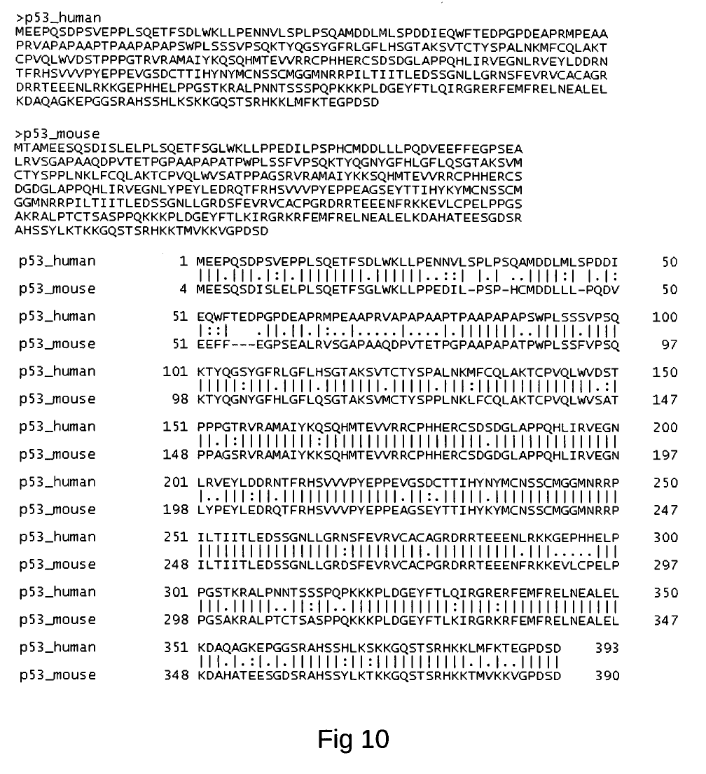

FIG. 10 is a comparison between a human gene and a mouse gene using a GPU;

FIG. 11 is a screenshot showing the content of the frame buffer after scoring has been computed by the GPU;

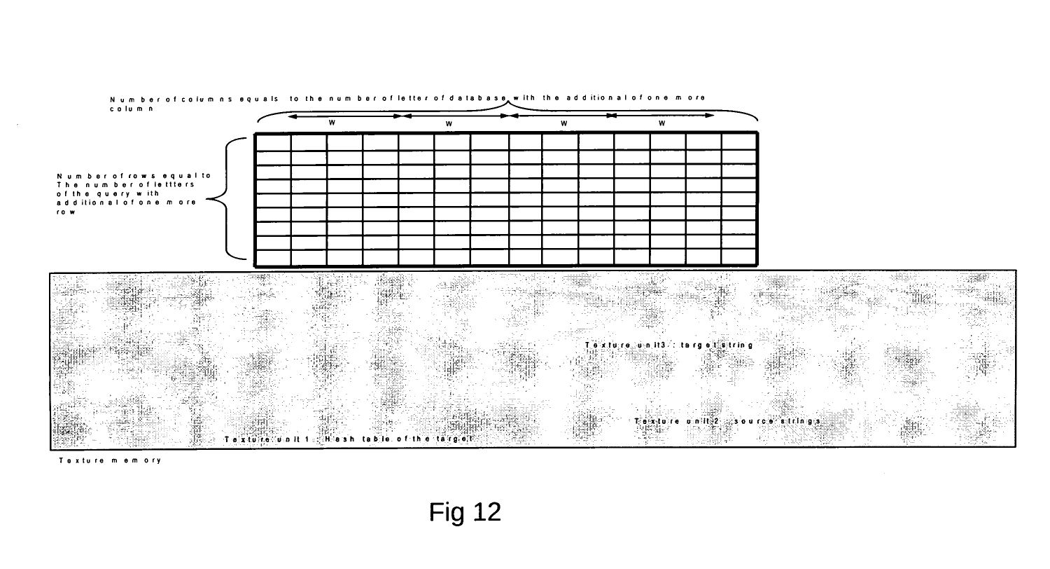

FIG. 12 illustrates the arrangement of memory in the GPU during operation of an embodiment of the invention;

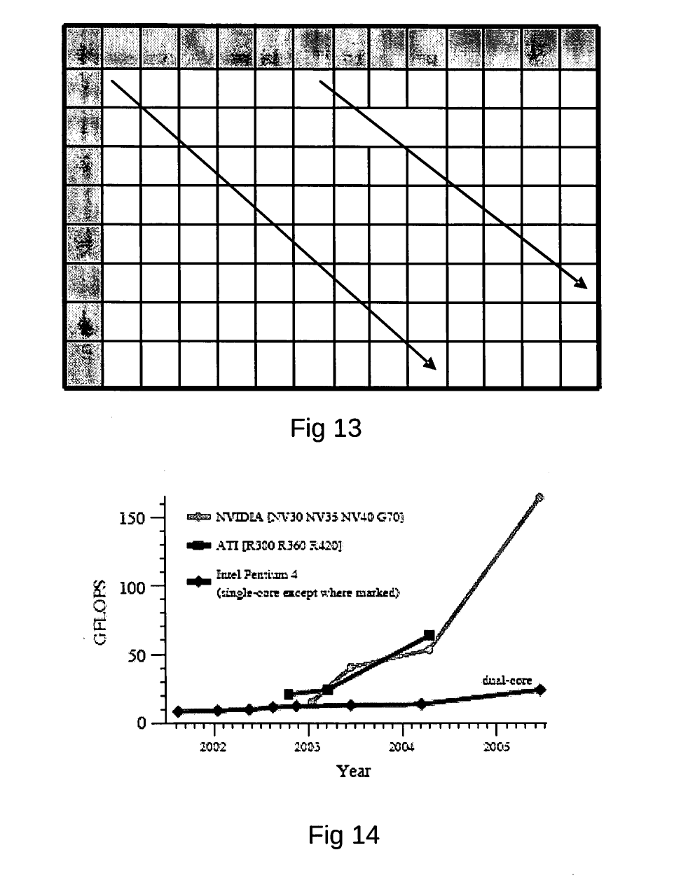

FIG. 13 is a representation of the frame buffer after the final render pass indicating where diagonals are located in the first row to aid transfer of data form the GPU to the CPU, and has already been discussed;

FIG. 14 is a graph that shows the relative increase in processing capacity of general purpose central processing units and graphical processing units;

FIG. 15 is an example of a score matrix constructed during performance of the Smith-Waterman algorithm; and

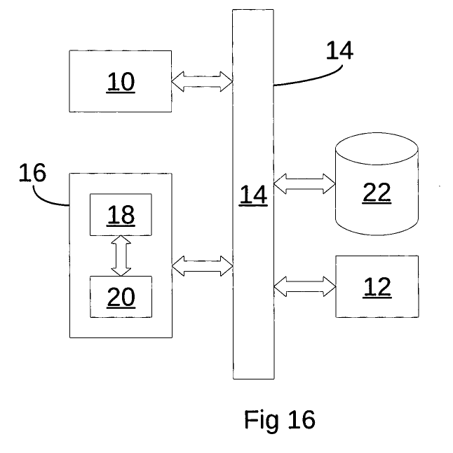

FIG. 16 is a simple block diagram of a computer system on which an embodiment of the present invention can be implemented.

### INTRODUCTION TO THE EMBODIMENTS

Embodiments of the present invention can be implemented on hardware that can be found in a standard desktop computer. The relevant components of such a computer will be described briefly, with reference to FIG. 16.

The computer has one or more central processing unit (CPU) 10, each having one or more processing core, that can execute arbitrary programs. The CPU 10 can communicate with general-purpose random access memory (RAM) 12 for reading and writing. The RAM can store code to be executed by the CPU 10 and data upon which the CPU 10 can operate under program control. Connected to the CPU by a system bus 14 is one or more graphics card 16. The main function of the graphics card 16 is to generate signals for controlling a video monitor. The (or each) graphics card 16 includes one or more graphics processing unit (GPU) 18 and graphics memory 20. The GPU 18 has direct, high-speed access to the graphics memory 20 for read and write operations. One region of the graphics memory is known as the framebuffer. The graphics card 18 includes hardware that reads the contents of the framebuffer and generates an output signal whereby the contents of the framebuffer dictate the appearance of individual pixels on the video monitor. The computer also typically includes a non-volatile backing store 22 such as a hard disk drive in which data can be stored in the longer term.

The GPU implements a graphics pipeline 18. The graphics pipeline is traditionally structured as stages of computation connected by data flow between stages. This structure is analogous to the stream and kernel abstraction of the stream programming model. Data flow between stages in the graphic pipeline is highly localized, with data produced by one stage immediately being consumed by elements of the next stage; in the stream programming model, streams are passed between kernels exhibit similar behaviour. The computation involved in each stage of the pipeline is typically uniform across different primitives, allowing these stages to be easily mapped to kernels. More recent GPUs allow individual kernels in the graphic pipeline to be programmed.

Data can be transferred between the CPU and the GPU over the system bus 14. For this, instructions contained in the OpenGL or DirectX API are used. Each of these instructions takes parameters. In the present case, these parameters are used to transmit the data that must be transferred to the graphics memory and be made available onto the GPU. These instructions can be considered as a wrapper to provide the necessary data to the GPU. Each of these two APIs has instructions which include: instructions for drawing geometrical figures, such as triangles, quads, or points; each of the geometrical figures having one or several vertices; and each vertex having geometrical coordinates and can have normal coordinates, texture coordinates and colour associated with it.

The GPU includes vertex processors and fragment processors. A vertex processor is a programmable unit that operates on in-coming vertex values and their associated data. The vertex processor usually performs traditional graphics operations such as vertex transformation, normal transformation (and normalisation), texture coordinate generation, texture coordinate transformation, lighting and colour material application. Due to its general-purpose programmability, a vertex processor can also be used to perform a variety of other computations which are termed “shaders” in graphics processing technology. Shaders that are intended to run on this processor are called “vertex shaders”. Furthermore, vertex shaders can specify a completely general sequence of operations to be applied to each vertex and its associated data. Modern GPUs have multiple vertex processors.

A fragment processor (also known as a pixel processor) is a programmable unit that operates on fragment values and their associated data. The fragment processor usually performs traditional graphics operations such as texture access, texture applications, fog and colour sum. Furthermore, a wide variety of other computations can be performed on this processor. Shaders that intend to run on this processor are called “fragment shaders”. To support parallelism at the fragment-processing level, fragment shaders are written in a way that expresses the computation required for a single fragment, without access to neighbouring fragments. The fragment processor can perform operations on each fragments that is generated by the rasterisation of points, lines, polygons, pixel rectangles and bitmaps. Furthermore, images can be loaded directly into the texture memory, from where the fragment processor can read the data and then perform pixel processing that requires access to a pixel and its neighbours. Modern GPUs have multiple unified fragment and pixel processors.

Application program interfaces, such as “Compute Unified Device Architecture” (CUDA), allow a programmer to use the C programming language to code algorithms for execution on the GPU. These assist in using GP Us to perform general-purpose computation; so-called “General-purpose computing on graphics processing units” (GPGPU) techniques.

### Frame Buffer and Texture Memory

Ultimately, the results from the fragment processor are written into the frame buffer. The frame buffer can then be called by API graphic library instructions (like OpenGL or DirectX) to send these data to the CPU. The results can also be directly written to the texture memory. This means that the results written into the texture memory can be accessed by the fragment processor and the vertex processor in the next rendering pass. For this reason the texture memory can be considered as a sort of temporary and working memory, albeit with some additional restrictions, compared to RAM directly accessible by the CPU.

Applications are required to set up and initialize texturing state before executing a shader that access texture memory. Typically, the following steps are required:
select a specific texture unit, and make it active;
create a texture object, and bind it to the active texture unit;
set various parameters of the texture object; and
define the texture.

Beside these steps, it is also important to define how to access these values stored in the texture memory. For this, texture coordinates are used. They are associated with each fragment and can therefore be used by the fragment processor to retrieve stored values in the texture memory. In this embodiment, the texture is either two-dimensional or one-dimensional. A two-dimensional texture will be used as an example to explain how values stored in that texture memory can be retrieved.

A feature of a texture is that its coordinates must be normalized between 0 and 1 since any scenes must be size-independent. In the interest of efficiency, the present invention builds a grid which can be either one-dimensional or two-dimensional. The elements of the grid are quads (but could alternatively be triangles). Each element represents a position in the texture. Each geometrical element has texture coordinates so that, when it is processed by a vertex shader, all the geometry transformations can be applied to it resulting in fragments having the correct texture coordinates pointing at the correct corresponding location in texture memory. Therefore, the fragment processor can retrieve different results in texture memory according to the fragment that is being processed.

An example of this will now be described. Suppose that there is a grid of quads. Since the size of each quad is the same, and by using the coordinates of the centre of a quad, it is possible to retrieve the different values stored in the texture at different locations starting from the position referenced by the centre of the quad in texture memory. To illustrate this, suppose that the value of the (i, j)^{th} quad of the grid is to be retrieved. To do this, the texture coordinates associated with the vertices of that quad point to the centre of the quad, represented by a number of pixels in texture. Given the size of a quad (Δ) and given the size of the texture, it is possible to retrieve the values associated to the (i−1, j)^{th} quad (representing the (i−1, j)^{th} element), the value of the (i−1,j−1)^{th} (representing the (i−1,j−1)^{th} element) and the value of the (i, j−1)^{th} quad (representing the (i,j−1)^{th} element). (See FIG. 6.)

For each fragment, the fragment shader may compute colour, depth and arbitrary values or completely discard the fragment. If the fragment is not discarded, the results of the fragment shader are sent on for further processing.

The basic primitives of 3D computer graphics are 3D vertices in projected space, represented by an (x, y, z, w) vector and four component colours stored as (red, green, blue, alpha). Furthermore, vertices can also have a normal vector and texture coordinates. By drawing the geometry with these vectors, the vertex will transform the geometry, and a rasteriser will be linearly interpolate the coordinates at each vertex to generate a set of coordinates for each fragment. The interpolated coordinates are passed as input to the fragment processor. These coordinates are used as indices for texture fetches and can also be seen as an array of indices used for controlling the domain of computation.

Fragment processors take incoming interpolated coordinates to retrieve data from a texture store that applies to a particular fragment and then apply a fragment program to that particular fragment. Note however, that with present GPU architectures, the fragment program applies to all the fragments and operates in SIMD-parallel fashion. The current generation of graphic cards has several fragment processor so that these fragments can be computed in parallel.

A modern GPU is effectively a high-performance, data-parallel processor that implements two kernels in its graphics pipeline, these kernels being a vertex program where a program can be run on each vertex that passes through the pipeline, and a fragment program where a program can be run on each fragment. Both of these kernels permit single-precision floating-point (and, in the foreseeable future, double-precision floating-point) computation and, in suitable GPUs, can be programmed using languages such as Cg, OpenGL Shading Language or DirectX shader. Furthermore, these programmable GPUs are inexpensive, readily available, easily upgradeable, and compatible with many operating systems and hardware architectures.

The present inventors investigated the possibility and efficiency of implementing dynamic programming algorithms on GPUs. They found that dynamic programming algorithms can be transformed to match the capabilities of GPUs with the benefit of offering a better performance in terms of computation and in particular, in terms of biological sequence comparisons. Moreover, they have found that these methods and systems can be applied to other fields in which searches must be made for patterns within a large set of data, such as those mentioned in the opening paragraph, without major modification.

### Implementation of Non-Heuristic Algorithms on a GPU

A process by which dynamic programming can be implemented on a GPU for non heuristic algorithms will now be described, with particular reference to the Smith-Waterman algorithm for local and global sequence alignments using both simple gaps and affine gaps. However, the techniques described can be adapted to implement other algorithms.

To understand how this process can be performed on a GPU, it is important to appreciate the constraints involved in using a GPU for performing general computations. There are a number of relevant constraints. For most of the graphic cards available today, these constraints include:

The fragment processor performs the same fragment program on all fragments. This program is performed on a number of fragments in parallel, the number being depending on the number of fragment units supported by the graphic card and the speed at which a fragment can be processed.

Each fragment does not have access to the value of the other fragments during a rendering pass. The values of all the fragments in a rendering can only be made available to a fragment at the next rendering pass. Each fragment can use texture coordinates and the texture memory to retrieve results of the fragments being processed at previous rendering passes.

The fragments can only store depth and colour values. These values are stored in the FrameBuffer buffer. The values of the Feedback buffer can then be stored in texture memory to be used in the next rendering.

Present GPUs contain a depth buffer which is a full 24 bits and a colour buffer that contains 4 registers of 8 bits. There are called the Red, Green, Blue and Alpha channels.

A vertex can only support a geometrical vector of four floats, a texture coordinate of four floats, a normal vector of three floats and a colour vector of four floats.

The vertex processor will also run the same vertex program on each vertices in order to produce a number of fragments.

Despite these constraints, the graphics pipeline has the advantage of being able to perform a number of operations in parallel (and simultaneously) on a number of geometrical figures in order to produce a resulting image in pixels. In dynamic programming, the score can also be computed diagonally giving the advantage that the score of each element located on the same diagonal can be computed in parallel since each of these elements does not depend on the score of any other, but depends only on the score of the elements located on the diagonals previously calculated. Therefore, if the elements of an alignment matrix can be represented by a geometrical figure, then the GPU can process these elements in parallel.

Data must be transferred from the CPU of the computer on which a graphics card is installed onto the graphics memory which can be accessed by the GPU. For this, the present embodiment uses the instructions contained in the OpenGL or DirectX API which are understood by the GPU. Each of these instructions takes some parameters. In this embodiment, these parameters are used to transmit the data into the graphics memory. These instructions can be thought of as a wrapper to provide the necessary data to the GPU. Each of these two APIs comes includes instructions for drawing geometrical figure such as triangles and quads, where each geometrical figure has a number of vertices; and each vertex has geometrical coordinates, normal coordinates, texture coordinates and colours.

### Assumptions

The algorithm of this embodiment makes a number of assumptions, as will now be described.

Each element of the alignment matrix is represented by a simple geometrical primitive. This is to allow the graphic pipeline to process them in parallel. To achieve this, these geometrical primitives are represented in a vector format that allows a rasterisation stage within the GPU to generate useful fragments in a raster format, which will then be processed by the fragment processor. The geometrical primitives used in the present embodiment are quads. The quads are represented by four vertices and the coordinates of the vertices are exactly as if the alignment matrix would have been represented in a geometrical system in which its element would have a position in (x, y, I) direction. As shown in FIG. 3, the first vertex of the element a₀₀ is at position (0, 40, 0) if the size of an element is 10. (In alternative embodiments, the geometrical primitives might be triangles or points.)

The buffer object is used to store the normal vectors, the colours, the vertex coordinates and the texture coordinates associated with each vertex.

The fragment processor uses the texture memory to store a score represented in texture by the depth and to store backtracking information represented in texture by the colour. These results are used by the fragment processor to retrieve the values related to a particular quad, which, in this embodiment, represents a particular element of the alignment score matrix alignment.

The algorithms used in sequence alignments must often retrieve the values of previous elements in order to compute a new value of an element. For instance, in dynamic programming, the score of an element can only be computed by retrieving the values of previous elements which have been computed. To achieve this on the GPU, the fragment processor must have a mechanism to retrieve previous values. There must be a one-to-one mapping between the texture coordinates generated in the vertex processor and the geometry of the elements. To achieve this, an orthogonal projection is used, as illustrated in FIG. 4.

The fragment processor retrieves data form the correct position in texture memory according to the address of the quad. The fragment processor must be able to find the centre of the quad. In order to avoid overloading the GPU with an excessive amount of data being passed from CPU to GPU, the centre of each quad is found by as a function of the size of a quad and the coordinates of the first vertex, as illustrated in FIG. 5.

All of the quads are the same size. Therefore by using the coordinates of the centre of a quad, it is possible to retrieve specific values stored in the texture memory at different locations, by starting from the position referenced by the centre of the quad in texture memory. To illustrate this, suppose that the value of the (i,j)^{th} element of the matrix alignment in a dynamic programming process is to be retrieved. To do this, the texture coordinates associated with the vertices of the quad representing an element point to the centre of the quad (this being represented by a number of pixels in texture). Since both the size of a quad (Δ) and the size of the texture are known, it is possible to retrieve the values associated to the (i−1, j)^{th} quad (representing the (i−1, n^{th} element), the value of the (i−1,j−1)^{th} (representing the (i−1,j−1)^{th} element) and the value of the (i,j−1)^{th} quad (representing the (i,j−1)^{th} element). This is illustrated in FIG. 6.

In order to retrieve specific values stored in texture, the coordinates must be normalised according to the size of the texture. Assume, for example, that the texture has a size of 256×256, and assume that the score for the (i,j)^{th} element must be retrieved. Using the coordinates of the centre of the (i,j)^{th} quad representing that element, and normalizing them according to the size of the texture, it is then possible to retrieve from texture memory the values of the (i−1 j)^{th} element, the (i,j−1)^{th} element and the (i−1,j−1)^{th} element. The normalized coordinates are as follows:

The value for the (i−1,j)^{th} element is given by the texture coordinates:

$$( {tx}_{i} , {ty}_{j} - \frac{Δ}{256} ) .$$

The value for the (i,j−1)^{th} element is given by the texture coordinates:

$$( {tx}_{i} - \frac{Δ}{256} {ty}_{j} ) .$$

The value for the (i−1,j−1)^{th} element is given by the texture coordinates:

$$( {tx}_{i} - \frac{Δ}{256} {ty}_{j} - \frac{Δ}{256} ) .$$

### Computation of String Comparisons Through the Rendering Process on GPUs

There are three main elements that must be put in place so that the GPU can start to make the necessary computations for strings comparisons. These elements are:

wrapping the necessary data through the geometrical coordinates, the normal coordinates, the texture coordinates and the colour coordinates of each vertices from each quads;

computation of the coordinates of the centre of each quad and their normalisation according to the size of the texture; and

transformation of the data from the vertex processor to the fragment processor.

### Rendering of the Quads

The GPU renders a number of quads in parallel. The number of rendering corresponds to the actual number of iterations required to find the result of a string comparison. Since graphics cards have a number of fragment processors and vertex processors, quads are rendered in parallel by the vertex processors. The vertex processors then generate a corresponding number of fragments. These fragments are then sent to the fragment processors, which perform the same fragment algorithm in parallel on the fragments.

The algorithm presented here has an initial stage that performs a first rendering to initialise the texture memory with correct initial values. Then follows a number of rendering stages according to the number of iteration for a string comparisons are performed. The rendering process is presented in FIG. 7.

### Rendering and Multi-Texturing

A completed render pass means that all the geometry, such as the quads forming the grid, are sent to the graphic pipeline and have been processed. At the end of the rendering, their results are available in the frame buffer or in texture memory. The results are a colour and a depth value associated with each pixel.

In order to compute results which are dependent on previous ones stored in texture, multi-pass rendering can be performed. It is important to realize that the cost of computation will depend on the number of fragments to be rendered, but they will be rendered in parallel using multiple fragment processors available on the GPU which significantly reduces overall execution time compared with sequential processing schemes.

Furthermore, it is often the case that we want to group results according to a specific computation. For this, texture can be partitioned into a set of virtual layers where each part of the texture can be retrieved by an identifier. Doing so, results of a previous rendering pass can be grouped under one id and others into different ids. The process of doing this is known as multi-texturing. This technique is used extensively in implementations of BLAST used in embodiments of the present invention.

### Smith-Waterman Alignment Performed on GPU

The algorithm assumes that the substitution matrix is located on the CPU. This means that there is a small cost involved in retrieving the scoring values from RAM before the GPU can make a Smith-Waterman alignment. This also constrains the way data are sent from the CPU to the GPU because the substitution values must be wrapped as value for the parameters of graphic instructions before being sent to the GPU.

### Substitution Matrix on CPU

The algorithm starts by scanning the two strings of characters representing amino acids or proteins for a pairwise comparison and retrieves the substitution values for each character. The algorithm assumes that the values of the substitution matrix are located in RAM, and therefore, these values are retrieved by the CPU. The substitution matrix can be, for example, a BLOSUM or a PAM matrix, the definitions of which are well known to those skilled in the technical field. The substitution matrix contains a number of columns equal to the number of characters and a number of rows which is also equal to the number of characters. For each character in the strings, its score will be retrieved by looking at its position column-wise and row-wise. For example, letter “A” for BLOSUM62 has a value 4.

This means also that the CPU performs the operation of retrieving each value of the two strings for a pairwise comparison. That is, if the length of one string is n and the length of the other string is m, then the CPU time for retrieving all the values will be the order of O(nm).

### Alignment Score Matrix

The second step in the algorithm is to arrange for the substitution values to be sent to the GPU. To achieve this, the substitution values are wrapped as values to parameters of graphical instructions which are interpreted by the GPU. The GPU then unwraps these values passed as arguments to create graphical instructions that can be interpreted by the GPU.

The alignment score matrix is represented as a number of quads. Each quad represents an element of the alignment score matrix. These quads have various roles namely;

Representing an element of the alignment score matrix and therefore, information about the element of the alignment score matrix can then be passed to the GPU by being values of parameters for the different graphic instructions. These values are used to relate the position of an element of the alignment score matrix with its position in texture memory. That way, it is possible first to retrieve score of any element and second, to compute the score of a particular element. In other words, they provide a way to make a one-to-one mapping between the element of an alignment score matrix and the position of that element in texture memory.

Providing a way to embed the different substituting values for the element of an alignment score matrix.

Providing a way to tell the GPU to compute the score of an element of the alignment score matrix at a certain time.

Giving a means for embedding other kind of information which can then be interpreted by the vertex processors and the fragment processors.

In the algorithm of the present embodiment, the set of quads represents an imaginary grid. Each quad can then be used to represent an element of a particular alignment score matrix. Furthermore, it also means that if the grid has some space free, other strings comparisons can be done in parallel. That way, several pairwise alignments can be performed in parallel resulting in multi-sequence comparisons to be performed on a standard GPU. It also provides flexibility when it comes to having to split a pairwise alignment in case the corresponding alignment score matrix is too large for the GPU memory.

The CPU generates a grid composed of multiple quads. This need be done only once when the algorithm is run for the first time. The algorithm builds these quads as follows: each quad has four vertices each including four coordinates. These coordinates are stored in an array which is sent to the GPU using an instruction such as glBufferDataARB from the OpenGL API. The values for the coordinates are the (x, y) coordinate values for a vertex, the next two values are the coordinates (x, y) corresponding to the first vertex of the quad representing the element situated on the left side. This is referred to as the geometry array vertexGeomArray.

Associated with each vertex of a quad, there are texture coordinates which are stored in an array that is also sent to the GPU by an instruction such as glBufferDataARB from the OpenGL API. The values for the first two coordinates are the coordinates of the first vertex of the quad representing the element situated on the diagonal above it. The values for the last two coordinates are the coordinates of the first vertex of the quad representing the element situated above it. This is called the geometry array textArray.

For each vertex, colour coordinates are used to state if the quad represents a boundary element of the alignment score matrix. These coordinates are stored in an array which is sent to the GPU using instruction glBufferDataARB from the OpenGL API. The colour coordinates for a vertex includes three coordinates. The first coordinate contains a value of 1.0f (that is, 1.0 as a floating-point value) and is not used in this embodiment. The next two values are the coordinates of the vertex of this quad and are used by the fragment processor to determine the position of that quad in texture memory. These values also need to be normalised according to the size of texture. These values are important, because they are needed to retrieve the correct values corresponding to an element of the alignment score matrix stored in texture memory. This geometry array is called colorArray.

Each vertex associated with a quad also has normal coordinates that comprise three coordinates. The first two coordinates are the values for opening a gap (ρ) and for extending a gap (σ). The third coordinate can be the substitution values for an element of the alignment score matrix; or, if a boundary element, the length of the query string; or 0.0f if it is element (0, 0) (this will be used for retrieving the maximum). Furthermore, only this array need be updated and sent to the GPU for each new pairwise alignment request. This will be called geometry array “normalArray”.

An important point to note in the algorithm is that each quad has the same size and each has the shape of a square having width equal to the height. This means that, given the position of a quad in texture memory, the fragment can also find the values stored in texture memory for every other quad. Remember that the values stored in texture are those from the previous rendering. This means that once a pixel processor computes the score for a quad representing a particular element in the alignment score matrix, it cannot access the values of the score being computed for the other quads in the same rendering. This quad can only access the values of the quads computed at the previous rendering and which have been stored in texture. This is illustrated in FIG. 8.

### Vertex Processor

The CPU sends all the above arrays to the GPU using, for example, the glEindBufferARB( . . . ) instruction from OpenGL. These arrays are then processed by a vertex processor of the GPU. Each vertex processor receives the arrays as vertices such as position given by the vertex coordinates, the texture coordinates, the normal coordinates and the colour coordinates. Using a shader program, the values are then unwrapped and stored in appropriate texture arrays, which are sent to the pixel shader processors as fragments generated by the GPU for each quad.

### Fragment Processor

The fragment processor receives three texture coordinates for each fragment, these having the values given by the vertex processor.

The fragment processor also contains four different parameters, which are general parameters for all the fragments. They include the identifier of the texture memory so that pixel processors know from which texture to retrieve the values. Using the shader program for the fragment processor, the GPU can compute a score for each fragment. The computation of the score follows the Smith-Waterman algorithm.

### Computation of the Score

Computation of the score is performed by the GPU for each fragment operating on a quad of the grid representing an alignment score matrix. Once it has been computed, the score is stored as a depth value. A back-tracking value is stored as a colour value. The depth and the colour value are then sent to the frame buffer memory. (The frame buffer is normally used to store the values of all pixels visible on a display screen.)

Since affine gaps are used, computation of the score of an element is done in three renderings. These are a first rendering for computing the value PScore(elementᵢⱼ), a second rendering for the computation of the value QScore(elementᵢⱼ) and a third rendering for computing the actual score i.e. Score(elementᵢⱼ). Scores of elements on the same diagonal are computed by the fragment processors at the same time. During each rendering, the score of the matrix alignment is stored in a separate texture. Therefore, four textures are used: one for PScore, one for QScore, one for the total score, and an additional texture is used to store colour information. The colour information not only stores back-tracking information (as described below), but also stores the order in which the algorithm must compute the different score resulting in the final score.

Through use of this additional texture, the algorithm ensures that the score of an element is computed only if, the score for the element to the left in the matrix, the element above in the matrix and the diagonal element are all available. To achieve this, the algorithm takes advantage of there being colour information having three values (one each for the red, the green and the blue channel) in the texture. The value in the red channel is used to indicate which score is to be processed. The order is PSscore, followed by QScore and then the final score. The value for green channel is used to contain the back-tracking information and it represents this information by indicating whether a score is already available for a particular element.

### Backtracking

Backtracking information is stored as a colour value representing the direction in the alignment score matrix of which element has contributed the most to the score of an element. Here we have the meaning of the stored colour values is set forth in Table 1, below.

TABLE 1

| Backtracking information | Meaning |
|---|---|
| 0.5 | The element having contributed the most to the |
| | actual score is the diagonal element |
| 0.8 | The element having contributed the most to the |
| | actual score is the left element |
| 0.7 | The element having contributed the most to the |
| | actual score is the Up element |
| 0.3 | There is no element having contributed the |
| | most and therefore, the score is zero. This |
| | means stop |

Backtracking can be done either completely on the CPU or partially on the GPU. In both cases, the CPU locates the element that has the maximum influence and then back-tracks from that element to an element having a score equal to zero by navigating through the matrix alignment using the backtracking information stored in the colour values.

Where backtracking is done entirely by the CPU, the backtracking information for each element of the alignment score matrix is retrieved by the CPU from the frame buffer of the GPU once the number of rendering passes necessary to compute the score of each element of the alignment score matrix for a pairwise comparison have been completed. The number of rendering passes for a particular pairwise comparison is equal to the length of the first string plus the length of the second string minus one. This also means that if the length of the first string is n and the length of the second string is m, then nm backtracking data items are transferred from the GPU to the CPU through an array. Then, the CPU scans this array to first identify the maximum and then back-tracks from the position of the element having a score equal to the maximum using the backtracking information. Therefore, the order of this computation in the worst case is O(nm) if and only if there is only one element having a maximum score.

Where backtracking is partly done on the GPU and partly on the CPU, the GPU can perform a number of steps to ease the process of backtracking on the CPU, and therefore reduce the computational order O(nm) on the CPU. To achieve this, the algorithm, adds an additional row and column to the alignment score matrix. The additional row and column have two roles. First, they are used to transfer information to the between the CPU and the GPU. Also, the additional row and column are used to delimit the boundary of the alignment score matrix (this is the also the mechanism to allow multi-pairwise string alignment on the same grid). This also means that these elements do not have any score. However, they are used to indicate the position of a maximum. A first rendering is done so that these elements will contain the position of the element row-wise containing the maximum per column. This is stored as a depth value. The colour information for these elements indicate if there is one or more maximum on the column. The CPU only retrieves from the frame buffer that row of boundary elements. The CPU then scans that row and retrieves the values indicating the position of the element on the column which has a maximum score. It does this for all the elements of that row, and stores the maxima in an array of position. The CPU then starts to back-track and make the final optimal alignments. As there can be several maxima located on a same column of the alignment score matrix, the GPU looks for other maxima in each column. This is done at the same time that the CPU makes the optimal alignments corresponding to the first set of maximum given earlier by the GPU. Therefore for the best case, where there is only one maximum, the computational order on the CPU is O(n) if and only if there is one element having a maximum score and where n is the length of the first string corresponding at the number of columns of the alignment score matrix. FIG. 9 describes the algorithm performed by the fragment processors to do this.

### Results

Embodiments have been tested against a test-bed software that is freely available and used in biology. The software is called JAligner (http://jaligner.sourceforge.net/). The authors of the software provided a test example which compares the gene of a mouse with a human gene. The two strings each have a length of 393 letters. The substitution matrix used here is the BLOSUM62 with an open gap cost of 10 and extension gap cost of 0.5.

FIG. 10 shows the result obtained and formatted in a pair alignment format, performed on a normal PC with a Pentium 4 CPU running at 3.07 GHz, having 1.00 GB of RAM with a GeForce 6200SE graphic card that includes 256 MB of graphics memory. The results obtained from the embodiment of the invention are the same as those obtained from, but the results were obtained in 75% less time. This provides a good indication that the sequence alignment can be executed faster using the GPU. Furthermore, the algorithm can be improved, since in this embodiment, the substitution matrix is loaded first on the CPU.

FIG. 11 shows a snapshot of what the framebuffer contains after scoring. Note that the rendering is normally performed using off-screen rendering and the content of the frame buffer is not displayed.

### Implementation of Heuristic Algorithms on a GPU

Implementation of heuristic algorithms on a GPU will now be described with reference to the BLAST algorithm.

In this section we will review how the first two steps reported in above have been transformed so that they can be implemented on a GPU to perform BLAST.

### Initial Set-Up

In the GPU implementation of the BLAST algorithm, four different grids are constructed. Each of these grids allows the fragment processor to perform the first two steps of BLAST correctly as the different values stored in the different textures (one for each grid) can be correctly retrieved.

The first grid is built to represent a hash table used at the beginning of BLAST when the query is split into a number of words having a width of W. Each of these words are then compared to each word of a list containing all the words of length W formed with the alphabet of the strings contained in the database. A threshold T is used to judge the similarities between words using a scoring matrix like the amino acids scoring matrices (e.g., PAM120). Therefore, each position of the query is associated with a list of words that score more than T compared with the word of the query starting at this position. This grid represents this list of words of length W formed with the alphabet of the strings contained in the database. For this reason, the algorithm first builds a grid with quads for each letter. Each letter is also coded so that, later, the fragment processor can recognise it.

The second grid is a grid where each letter of the source string is stored. Each quad of the grid represents one letter of the source string. In other words, that grid could represent the complete database. Note also that it would have been possible to implement embodiments that use points, triangles, or many other type of geometrical entity instead of quads. Furthermore, this grid can be pre-computed and rendered in advance so that the results are stored in two textures.

The third grid is a grid corresponding to the query string. Each quad of the grid represents one letter of the target string. Note that the grid could be build to incorporate several query strings so that multiple query strings can be compared at the same time against the same database, allowing quence comparisons to be performed.

The fourth grid is a special grid which keeps the position of hits in a form of matrix hits. It has a number of rows corresponding to the number of letters of the target strings. If multiple targets are used, then the total number of rows is equal to the total number of rows of all the target strings. The number of columns is equal to the number of letters contained in the database. This grid is used also to regulate the flow of operations performed among the different vertex and fragment processors for the first two steps of the BLAST algorithm.

Each of these grids stores their results in separate texture units and, as such, multi-texturing is used extensively in this GPU implementation of BLAST. To set up the graphics pipeline so that BLAST can be performed on the GPU, the first three grids are rendered and the results are then stored in their respective textures.

A first rendering pass is then performed to store the results of the first grid in a first texture unit. In other words, this first texture unit contains the hash table: that is, more precisely, the fragment processor then stores in texture each W word in the form of a colour with the red channel containing the coded value corresponding to the first letter of the word, the green channel corresponding to the second letter of the word, the blue channel corresponding to the third letter. Note that for a word of 11 letters, then three quads of the grid are used to form that letter and the alpha channel will also be used associated with the first two quads.

A second rendering is then performed to store in texture memory the results of the second grid. This texture also contains colours that represent each letter of the string. Only one channel is used to code each letter in this embodiment. However, the algorithm can be further improved as the two other channels can also be used allowing to the denser coding of letters in texture memory.

In a manner similar to the second rendering pass, a third rendering pass is then performed for the target sequence. The resulting colours represent each letter of the string.

Once the previous three rendering passes have been performed, all the initialization stages have been completed and the next rendering pass performs the first two steps of the BLAST algorithm.

### Initial Search

The initial search starts by rendering the fourth grid where the number of rows corresponds to the number of words W of the target strings and where the number of columns equals to the number of words W of the source strings. Note that the number of columns can have several source strings depending on the memory of the graphic cards and on the texture memory already utilized. Furthermore, only the “words” of the source are being encoded through the graphic APIs instruction associated to each quads like vertex coordinates, texture coordinates, colours and normals. Note also that each quad of a column encodes the same letter of a word. A word typically contains 3 letters or 11 letters, but other word lengths are possible. In case of 3 letters, FIG. 12 summarizes the set-up for the initial search.

The algorithm performed by the fragment processor can be summarized as follows:

1. The fragment processor takes the texture coordinates associated with a fragment corresponding to a quad of the two-dimensional grid received by the vertex processor and encoded in the second grid. This quad encodes a letter of the word of the source string.

2. The fragment processor then looks to the first texture unit corresponding to the hash table encoded in the first grid having been rendered during the initial set-up. According to the row position related to a particular fragment being processed by a fragment processor, that fragment processor will then determine whether there is a match by comparing the encoded letter. If no match is found, then the fragment will shift on one position of word W and perform the comparison again.

3. If a match is found, then the fragment processor looks in the source encoded in the second grid. There, it shifts on one size from the position of the letter where there was a match in order to retrieve the second letter of the word. It then determines if the following letter in the hash table of that word is also a match. If no match is found, then the fragment shifts on word W and start the comparison again from step 2. Furthermore, if all the words of a row, in this first texture unit, corresponding to the row related to the fragment being processed has been scanned, then the alpha value of the colour for that fragment is set to 0.0f.

However, if there is a match, repeat this present stage and add one to the number of letters of that word matching the letter of a word in hash table in the first grid. If there are three matches in the case of W=3, then a hit has been found. The alpha channel of the fragment is then set to a value of 0.5f.

This is used later to ensure that there is a second hit on the same diagonal of the grid from which the fragment related to a quad has been generated. This allows implementations of the invention to accommodate the variations of the BLAST algorithms requiring two hits on a same diagonal.

### Initial Alignment

As a result of the previous rendering passes all the hits have been found. The resulting frame buffer contains pixels with an alpha which has been set to 0.5f or 0.0f depending upon whether or not a hit has been found. The contents of the frame buffer are then stored in a fourth texture unit. It contains only the colour. The second grid is then rendered a second time, during which the fragment processor retrieves the values associated with the fourth texture unit to determine whether or not the colour alpha channel has been set to 0.5f. If this is the case, the fragment processor determines whether or not an initial alignment can be performed for that fragment. If this is not the case, then it will just retrieve the colour corresponding to that fragment from the fourth texture unit and set its depth value to 0.0f.

To determine whether an initial alignment can be performed, it will perform a two hits check by way of:

The fragment processor checks if there are two hits on the diagonal of the quads for which the corresponding fragment is being processed by the fragment processor. To determine this, the fragment processor starts from that fragment and using the fourth grid seeks diagonally upwards for a second hit to be found within a certain distance D. If no hit is found, it performs the same process, but seeking diagonally downwards. For fragments where no second hit is found, the red channel is set to 0.5f and the depth value set to zero, indicating that this fragment has been processed and no second hit found. If, however, a double hit is found, the fragment processor sets the red channel to 0.8f, to indicate that this fragment has been processed and a second hit has been found on the same diagonal. If a double hit is found, the algorithm proceeds to the next stage (stage 5) as a first initial alignment can be performed. If no hits have been found, the algorithm performs a conditional branch directly to stage 8. If the global distance parameter D is set to zero, the fragment processor sets all the hits as having two hits on their diagonal and therefore all the red channels will be set to 0.8f. This is to allow implementation of some variants of BLAST such as BLASTN that do not require two hits.

If a second hit has been found then initial alignment can be performed. The fragment processor makes an additional shift in the texture unit corresponding to the source string and also an additional shift in the texture unit corresponding to the target string. If there is a match increase, it will increase the dropoff function by a value V. For example, V can be equal to 1. Note also, that the dropoff function can be modified by changing the fragment shader program and not the complete program. If no match is found, it will then decrease the dropoff by the value V.

The fragment processor repeats the above stage, checking the value of the dropoff and if it is less than a threshold TH, then it terminates this stage and goes to the next stage (stage 7).

The fragment processor stores the number of shifts performed in the upper diagonal direction as a depth value and the colour of the red channel will be set to the value of 0.9f indicating that the initial alignment has been done for that fragment upwards.

Once all the fragments have been generated, then the values in terms of depth and colour are available in the frame buffer. The content of the frame buffer is then copied to the textures i.e. the colour values are copied to the fourth texture unit. The depth values are copied to an additional texture unit called here the fifth texture unit.

An additional rendering of the two dimensional grid is then performed, but only where the fragments have the correct red channel value of 0.9f, are these further processed, but in a downwards diagonal direction using similar processes as detailed in stages 5 and 6. Upon successful completion, candidate fragments have their red channels set to 0.95f. The contents of the frame buffer in terms of colour is copied to the fourth texture unit corresponding to the two-dimensional grid and the content of the frame buffer in terms of depth values is sent to the CPU where it will be stored either in memory or on the hard disc.

For those fragments that do not have a colour with the red channel value of 0.9f, the fragment processors retrieve their colour and depth values from the respective texture units computed at the previous rendering, and the fragment processors send them directly to the frame buffer.

To accelerate the process of determining which positions of the grid contain useful sections, a final render pass is performed in which the quads associated with the row are then used to indicate which diagonals containing two hits, as shown in FIG. 13. This is used later by the CPU to retrieve the initial alignments.

Therefore, the cost of computing the first two steps of BLAST is of the order of seven rendering passes. Note that this will also depend on the number of vertex and fragment processors available on the GPU.

### Performance

A number of tests to assess the performance of the invention have been performed. The embodiment of the BLAST algorithm has been tested against the freely available software, geWorkbench and test files ran against NCBI-BLAST. An example of the results of the comparison is shown below with the E. coli secondary lambda attachment having a length of 122.

The score=121 bits (61_, Expect=3×10⁻²⁴, identities 64/65 (98%), Gaps=0/65 (0%) strand=Plus/Minus.

The test sequence is presented in Table 2. The result is presented in Table 3.

TABLE 2
AGCTTTTCATTCTGACTCGAACGGGCAATATGTCTCTGTGTGGATTAAAA
AAAGAGTGTCTGATAGCAGCTTCTGAACTGGTTACCTGCCGTGAGTAAAT
TAAAATTTTATTGACTTAGGTCACTAAATACTTTAACCAATATAGGCATA
GCGCACAGACAGATAAAAATTACAGAGTACACAACATCCATGAAACGCAT
TAGCACCACCATTACCACCACCATCACCATTACCACAGGTAACGGTGCGG
GCTGACGCGTACAGGAAACACAGAAAAAAGCCCGCACCTGACAGTGCGGG
CTTTTTTTTTCGACCAAAGGTAACGAGGTAACAACCATGCGAGTGTTGAA
GTTCGGCGGTACATCAGTGGCAAATGCAGAACGTTTTCTGCGTGTTGCCG
ATATTCTGGAAAGCAATGCCAGGCAGGGGCAGGTGGCCACCGTCCTCTCT
GCCCCCGCCAAAATCACCAACCACCTGGTGGCGATGATTGAAAAAACCAT
TAGCGGCCAGGATGCTTTACCCAATATCAGCGATGCCGAACGTATTTTTG
CCGAACTTTT

TABLE 3

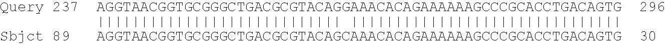

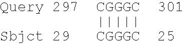

In this test case only one alignment result is returned and the GPU implementation of BLAST returned the same result.

Potential Modifications

The BLAST algorithm has undergone several modifications in order to improve it. Specifically, aims of making the improvements include maintaining selectivity, increasing sensitivity, decreasing computational requirements and providing better result alignments. One of these modifications uses an approach similar to the FASTA algorithm, where the maximal scoring segment is used to define a band that uses the Smith-Waterman algorithm to find a gapped alignment within the band. Subsequently, a new gapped BLAST algorithm was introduced to overcome the problem of being restrained within an alignment region bounded by the window size while avoiding the high computational cost of an unrestricted Smith-Waterman alignment by extending alignment out from a central high-scoring pair of aligned amino acids. These modifications can also be implemented using techniques of the present invention.

Intel, MMX, Pentium are registered trade marks of Intel Corporation 3D-Now, AMD are registered trade marks of Advanced Micro Devices Inc. DirectX is a registered trade mark of Microsoft Corporation OpenGL is a registered trade mark of Silicon Graphics, Inc.

1. A method of performing a pattern matching algorithm on strings of characters on a computer, which computer includes a central processing unit (CPU), main memory accessible for read and write operations by the CPU, a graphics processing unit (GPU), and graphics memory accessible for read and write operations by the GPU, in which the method includes a step in which data to be processed as part of the pattern matching algorithm is are transferred to the graphics memory, the GPU is operated to perform one or more processing step on the data, and following completion of the processing step, processed data are transferred from the graphics memory to the main memory.

2. The method according to claim 1 that comprises a step of constructing an alignment score matrix.

3. The method according to claim 2 in which the alignment score matrix is transferred to a texture memory that is accessible by the GPU.

4. The method according to claim 3 in which each element of the alignment score matrix is represented in the texture memory by a respective geometrical primitive.

5. The method according to claim 4 in which each geometrical primitive is one of a quad, a triangle, a point or another geometrical entity.

6. The method according to claim 4 in which the score information associated with each matrix element is represented by one of a colour or a depth value of the associated graphics primitive, and in which backtracking information associated with each matrix element is represented by the other one of a colour or a depth value of the associated geometrical primitive.

7. The method according to claim 3 in which the geometrical primitives are processed by a vertex processor of the GPU executing a vertex shader.

8. The method according to claim 7 in which the data generated by the vertex processor is stored as a respective fragment for each quad.

9. The method according to claim 8 in which the fragments are transmitted to a fragment processor which operates to process the fragment data in accordance with a fragment shader to compute a respective score for each fragment.

10. The method according to claim 9 in which output from the fragment processors is stored in an array in framebuffer memory.

11. The method according to claim 10 in which the fragment processor computes a backtracking value for each fragment.

12. The method according to claim 11 in which the backtracking value is stored in a location within frame buffer memory that corresponds to a fragment.

13. The method according to claim 11 in which backtracking values are transferred from graphics memory to main memory for subsequent processing by the CPU.

14. The method according to claim 13 in which the array contains a row and a column in addition to the rows and columns required to store the score and backtracking values.

15. The method according to claim 14 in which the additional row and column includes metadata that can indicate the presence of specific features within the score and/or the backtracking data.

16. The method according to claim 15 in which the metadata indicates the location of maxima within the score and/or the backtracking data.

17. The method according to claim 1 in which the pattern matching algorithm is a non-heuristic algorithm.

18. The method according to claim 17 in which the pattern-matching algorithm is the Smith-Waterman algorithm.

19. The method according to claim 1 in which four grids are constructed in texture memory of the GPU from source and target strings to be compared.

20. The method according to claim 19 in which a first grid represents a hash table of words of length Win the query string.

21. The method according to claim 19 in which a second grid is an array of graphical primitives, each of which represents a corresponding character of the source string.

22. The method according to claim 19 in which a second grid is an array of graphical primitives, each of which represents a corresponding character of a plurality of source strings.

23. The method according to claim 19 in which a third grid is an array of graphical primitives, each of which represents a corresponding character of the target string.

24. The method according to claim 23 in which the third grid is an array of graphical primitives, each of which represents a corresponding character of one of several target strings.

25. The method according to claim 19 in which a third grid is an array of graphical primitives that record the position of search hits.

26. The method according to claim 25 in which the fourth grid has a number of rows equal to the total number of characters in the target string or strings, and a number of columns equal to the number of characters in the source string.

27. The method according to claim 19 in which the first, second and third grids are each subject to rendering passes, and the results of the rendering passes are stored as respective textures.

28. The method according to claim 27 in which, in a first rendering pass, a fragment processor stores each element in the first grid in a channel of a first texture.

29. The method according to claim 28 in which each element of the first grid is stored in a respective channel of a texture.

30. The method according to claim 27 in which, in a second rendering pass, a fragment processor stores each element in the second grid in a channel of a second texture.

31. The method according to claim 27 in which, in a third rendering pass, a fragment processor stores each element in the third grid in a channel of a third texture.

32. The method according to claim 16 that includes an initial search phase in which the fourth grid is rendered by a fragment processor in which the hash table of the first grid is populated to indicate the location and size of localised matches between words in the target string and the source string.

33. The method according to claim 16 in which the pattern-matching algorithm is a heuristic algorithm.

34. The method according to claim 17 in which the pattern-matching algorithm is the BLAST algorithm or one of its derivatives.

35. A system for performing a pattern matching on strings of characters comprising computing apparatus including a central processing unit (CPU), main memory accessible for read and write operations by the CPU, a graphics processing unit (GPU), and graphics memory accessible for read and write operations by the GPU, and program code which, when executed by the CPU, causes the system to perform a method according to any preceding claim.

36. The system according to claim 35 in which the CPU includes one or more processors, each of which has one or more processing cores.

37. The system according to claim 35 including more than one GPU.
